(19) United States
(12) Patent Application Publication
(10) Pub. No.: US 2010/0310775 A1
(43) Pub. Date: Dec. 9, 2010

(54) Spalling for a Semiconductor Substrate

(75) Inventors: Stephen W. Bedell, Yorktown Heights, NY (US); Keith E. Fogel, Yorktown Heights, NY (US); Paul A. Lauro, Yorktown Heights, NY (US); Devendra Sadana, Yorktown Heights, NY (US); Davood Shahrjerdi, Yorktown Heights, NY (US)

Correspondence Address: CANTOR COLBURN LLP - IBM FISHKILL, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/713,560

(22) Filed: Feb. 26, 2010

Related U.S. Application Data
(60) Provisional application No. 61/185,247, filed on Jun. 9, 2009.

(51) Int. Cl. B05D 3/02

(52) U.S. Cl. 427/383.3

(57) ABSTRACT

A method for spalling a layer from an ingot of a semiconductor substrate includes forming a metal layer on the ingot of the semiconductor substrate, wherein a tensile stress in the metal layer is configured to cause a fracture in the ingot; and removing the layer from the ingot at the fracture. A system for spalling a layer from an ingot of a semiconductor substrate includes a metal layer formed on the ingot of the semiconductor substrate, wherein a tensile stress in the metal layer is configured to cause a fracture in the ingot, and wherein the layer is configured to be removed from the ingot at the fracture.

### CROSS-REFERENCE TO RELATED APPLICATION

This application claims the benefit of U.S. Provisional Application No. 61/185,247, filed Jun. 9, 2009. This application is also related to attorney docket numbers YOR920100056US1, YOR920100058US1, YOR920100060US1, and FIS920100006US1, each assigned to International Business Machines Corporation (IBM) and filed on the same day as the instant application, all of which are herein incorporated by reference in their entirety.

### FIELD

The present invention is directed to semiconductor substrate fabrication using stress-induced substrate spalling.

### DESCRIPTION OF RELATED ART

A large portion of the cost of a semiconductor-based solar cell may be due to the cost of producing a layer of a semiconductor substrate on which to build the solar cell. In addition to the energy costs associated with the separation and purification of the substrate material, there is a significant cost associated with the growth of an ingot of the substrate material. To form a layer of the substrate, the substrate ingot may be cut using a saw to separate the layer from the ingot. In the process of cutting, a portion of the semiconductor substrate material may be lost due to the saw kerf.

### SUMMARY

In one aspect, a method for spalling a layer from an ingot of a semiconductor substrate includes forming a metal layer on the ingot of the semiconductor substrate, wherein a tensile stress in the metal layer is configured to cause a fracture in the ingot; and removing the layer from the ingot at the fracture.

In one aspect, a system for spalling a layer from an ingot of a semiconductor substrate includes a metal layer formed on the ingot of the semiconductor substrate, wherein a tensile stress in the metal layer is configured to cause a fracture in the ingot, and wherein the layer is configured to be removed from the ingot at the fracture.

Additional features are realized through the techniques of the present exemplary embodiment. Other embodiments are described in detail herein and are considered a part of what is claimed. For a better understanding of the features of the exemplary embodiment, refer to the description and to the drawings.

### BRIEF DESCRIPTION OF THE SEVERAL VIEWS OF THE DRAWINGS

Referring now to the drawings wherein like elements are numbered alike in the several FIGURES:

FIG. 1 illustrates an embodiment of method for spalling for an ingot of a semiconductor substrate.

FIG. 2 illustrates an embodiment of an ingot of a semiconductor substrate with a seed layer.

FIG. 3 illustrates an embodiment of an ingot of a semiconductor substrate with an adhesion layer.

FIG. 4 illustrates an embodiment of a system for forming a stressed metal layer on an ingot of a semiconductor substrate.

FIG. 5 illustrates an embodiment of an ingot of a semiconductor substrate with a stressed metal layer.

FIG. 6 illustrates an embodiment of a spalled layer of an ingot of a semiconductor substrate.

FIG. 7 illustrates a top view of an embodiment of a spalled layer of an ingot of a semiconductor substrate.

### DETAILED DESCRIPTION

Embodiments of systems and methods for spalling for a semiconductor substrate are provided, with exemplary embodiments being discussed below in detail.

A layer of tensile stressed metal or metal alloy may be formed on a surface of an ingot of a semiconductor material to induce a fracture in the ingot by a process referred to as spalling. A layer of the semiconductor substrate having controlled thickness may be separated from the ingot at the fracture without kerf loss. The stressed metal layer may be formed by electroplating or electroless plating. Spalling may be used to cost-effectively form layers of semiconductor substrate for use in any semiconductor fabrication application, such as relatively thin semiconductor substrate wafers for photovoltaic (PV) cells, or relatively thick semiconductor-on-insulator for mixed-signal, radiofrequency (RF), or microelectromechanical (MEMS) applications.

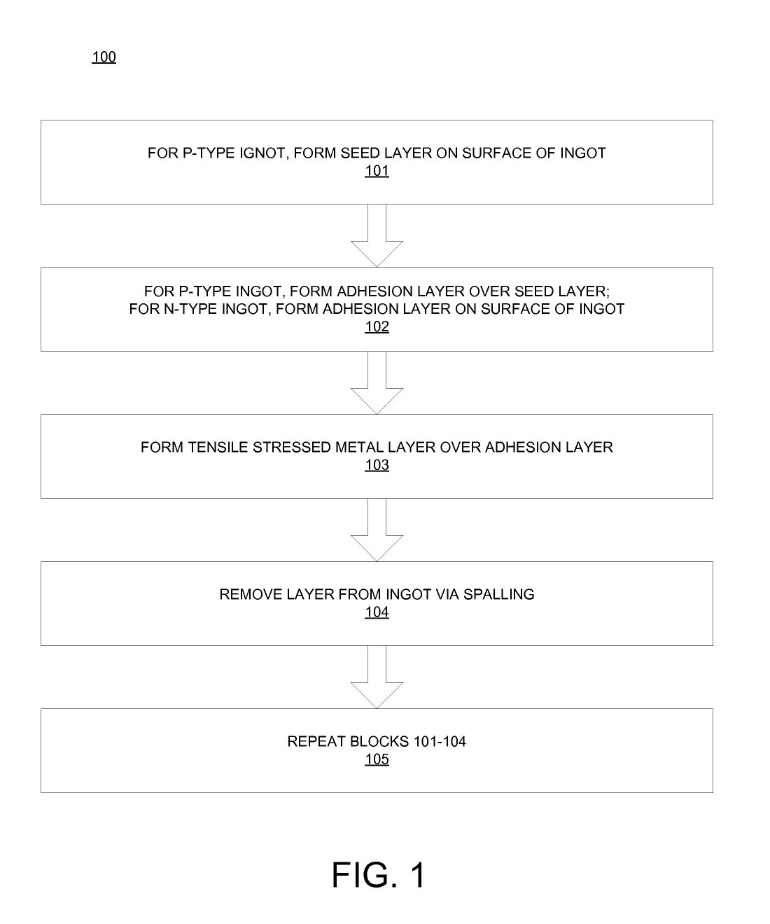

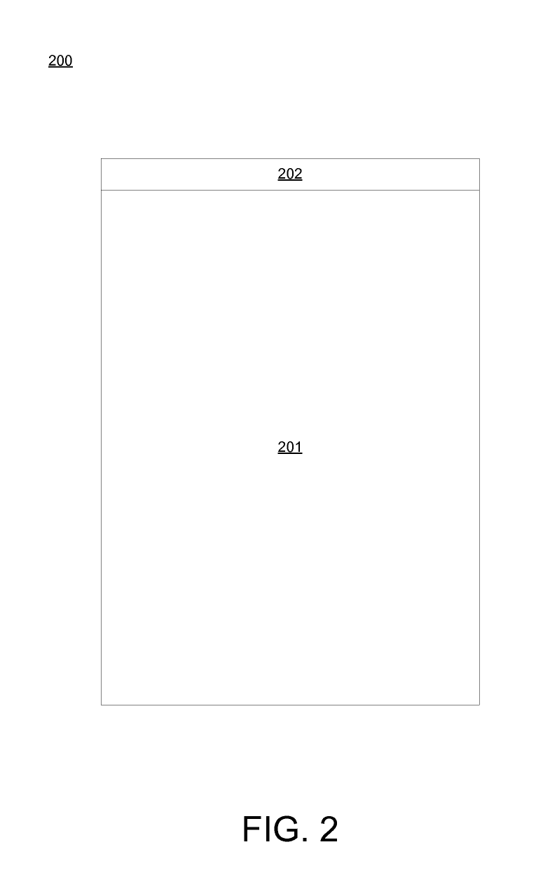

FIG. 1 illustrates an embodiment of a method 100 for spalling for an ingot of a semiconductor substrate. FIG. 1 is discussed with reference to FIGS. 2-7. The semiconductor material comprising the ingot may comprise germanium (Ge), or single- or poly-crystalline silicon (Si) in some embodiments, and may be n-type or p-type. For an n-type semiconductor material, block 101 is optional. In block 101, a surface of an ingot 201 of a semiconductor material that is to be spalled is pre-treated by forming a seed layer 202 on the surface of the ingot, as is shown in FIG. 2. The seed layer 202 is necessary for an ingot 201 of p-type semiconductor material (in which holes are the majority carriers), as direct electroplating on p-type material is difficult due to the surface depletion layer that may be formed when a p-type ingot 201 is subjected to a negative bias with respect to the electroplating solution. The seed layer 202 may comprise a single layer or multiple layers, and may comprise any appropriate material. The seed layer 202 may comprise palladium (Pd) in some embodiments, which may be applied to ingot 201 via immersion in a bath comprising a Pd solution. In other embodiments, in which the ingot 201 comprises Si, formation of the seed layer 202 may comprise forming a layer of titanium (Ti) on ingot 201, and forming a silver (Ag) layer over the Ti layer. The Ti and the Ag layers may each be less than about 20 nanometers (nm) thick. Ti may form a good adhesive bond to Si at low temperature, and the Ag surface resists oxidation during electroplating. The seed layer 202 may be formed by any appropriate method, including but not limited to electroless plating, evaporation, sputtering, chemical surface preparation, physical vapor deposition (PVD), or chemical vapor deposition (CVD). The seed layer 202 may be annealed after formation in some embodiments.

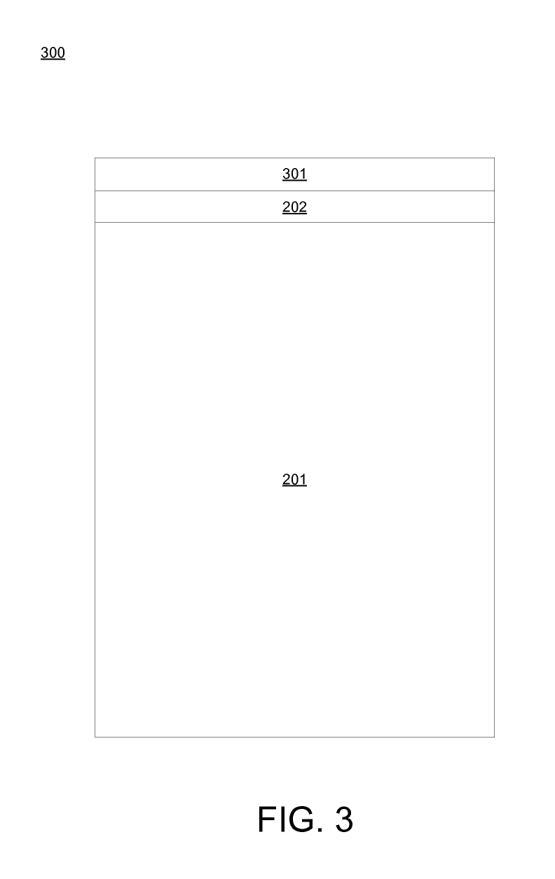

In block 102, an adhesion layer 301 of a metal is formed on the ingot 201. For embodiments comprising a p-type ingot 201, the adhesion layer 301 is optional, and formed over the seed layer 202 as is shown in FIG. 3. For embodiments comprising an n-type ingot 201, the adhesion layer is formed directly on the ingot 201, and there is no seed layer 202. The adhesion layer 301 may comprise a metal, including but not limited to nickel (Ni), and may be formed by electroplating or by any other appropriate process. The adhesion layer 301 may be less than 100 nm thick in some embodiments. Formation of the adhesion layer 301 may be followed by annealing to promote adhesion between the metal adhesion layer 301, the seed layer 202 (for p-type semiconductor material), and semiconductor ingot 201. Annealing causes the adhesion layer 301 to react with the semiconductor material 201. Annealing may be performed at a relatively low temperature, below 500° C. in some embodiments. Inductive heating may be used for annealing process in some embodiments, allowing heating of the metal adhesion layer 301 without heating the ingot 201.

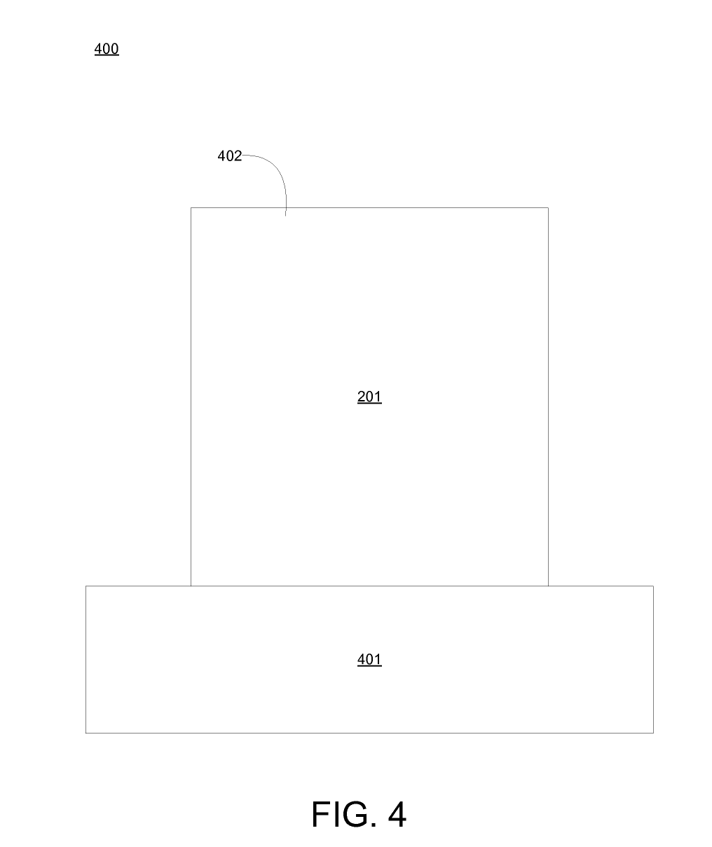

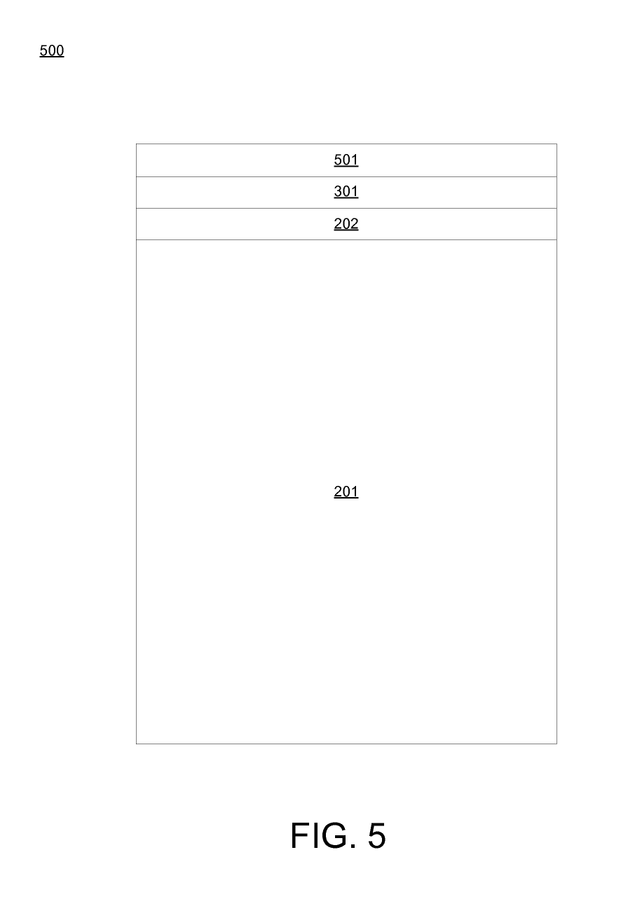

In block 103, electroplating (or electrochemical plating) is performed by immersing the surface of ingot 201 comprising adhesion layer 301 in a plating bath 401, and applying a negative bias 402 with respect to plating bath 401 to the ingot 201, as is shown in FIG. 4. The plating bath 401 may comprise any chemical solution capable of depositing a stressed metal layer 501 (as shown in FIG. 5) on the ingot 201 either autocatalytically (electroless) or upon application of external bias 402. In an exemplary embodiment, plating bath 401 comprises a 300 gram/liter (g/l) aqueous solution of NiCl₂ with 25 g/l of boric acid. The plating bath temperature may be between 0° C. and 100° C. in some embodiments, and between 10° C. and 60° C. in some exemplary embodiments. The plating current flowing in ingot 201 during electroplating may vary; however, the plating current may be about 50 mA/cm² in some embodiments, yielding a deposition rate of about 1 micron/min. Prior to electroplating, if any oxide layers have formed on adhesion layer 301, these oxide layers may be removed chemically. For example, a diluted HCl solution may be used to remove oxide layers from an adhesion layer 301 comprising Ni.

Electroplating causes stressed metal layer 501 to form on adhesion layer 301, as is shown in FIG. 5. FIG. 5 shows an embodiment of an ingot 201 comprising p-type semiconductor material, with a seed layer 202. If the ingot 201 comprises n-type semiconductor material, seed layer 202 is not present. The stressed metal layer 501 may be between 1 and 50 microns thick in some embodiments, and in between 4 and 15 microns thick in some exemplary embodiments. The tensile stress contained in metal layer 501 may be greater than about 100 megapascals (MPa) in some embodiments.

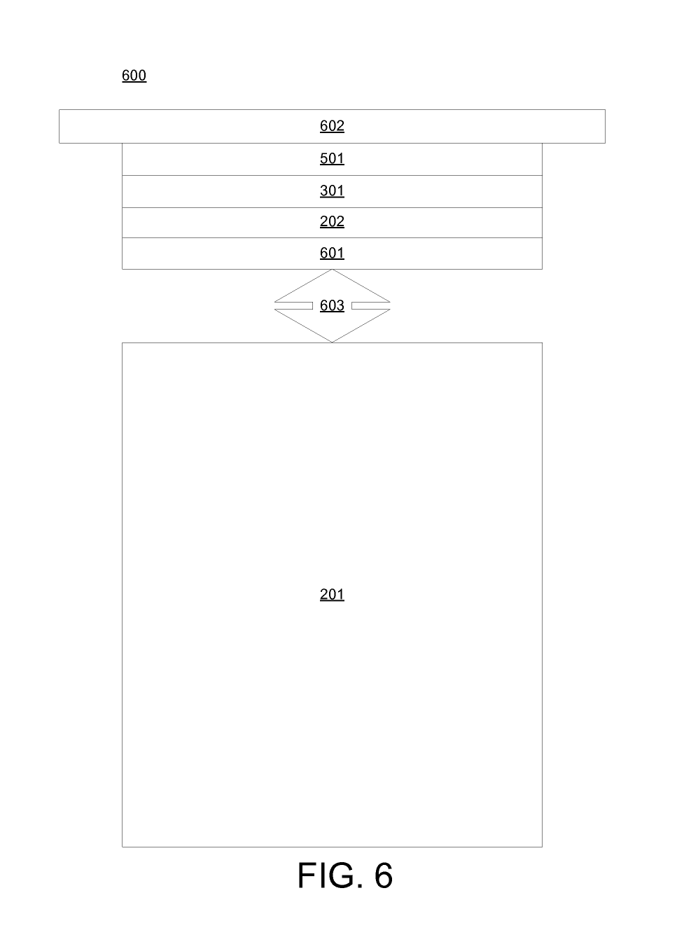

In block 104, semiconductor layer 601 is separated from ingot 201 via spalling at fracture 603, as is shown in FIG. 6. FIG. 6 shows an embodiment of an ingot 201 comprising p-type semiconductor material, having a seed layer 202. If the ingot 201 comprises n-type semiconductor material, seed layer 202 is not present. Spalling may be used in conjunction with an ingot 201 having any crystallographic orientation; however, fracture 603 may be improved in terms of roughness and thickness uniformity if fracture 603 is oriented along the natural cleavage plane of the material comprising ingot 201 (<111> for Si and Ge).

Spalling may be either controlled or spontaneous. In controlled spalling (as shown in FIG. 6), a handle layer 602 is applied to the metal layer 501, and is used to induce fracture in the ingot 201 to remove the semiconductor layer 601 from the ingot 201 along fracture 603. The handle layer 602 may comprise a flexible adhesive, which may be water-soluble in some embodiments. Use of a rigid material for the handle layer 602 may render the spalling mode of fracture unworkable. Therefore, the handle layer 602 may further comprise a material having a radius of curvature of less than 5 meters in some embodiments, and less than 1 meter in some exemplary embodiments. In spontaneous spalling, the stress contained in the stressed metal layer 501 causes semiconductor layer 601 and the stressed metal layer 501 to spontaneously separate themselves from the ingot 201 at a fracture, without the use of a handle layer 602. Controlled spalling may be made to become spontaneous spalling upon heating of the stressed metal 501. Heating tends to increase the tensile stress in the stressed metal 501, and can initiate spontaneous spalling. Heating may be performed in any appropriate manner, including but not limited to a lamp, laser, resistive, or inductive heating.

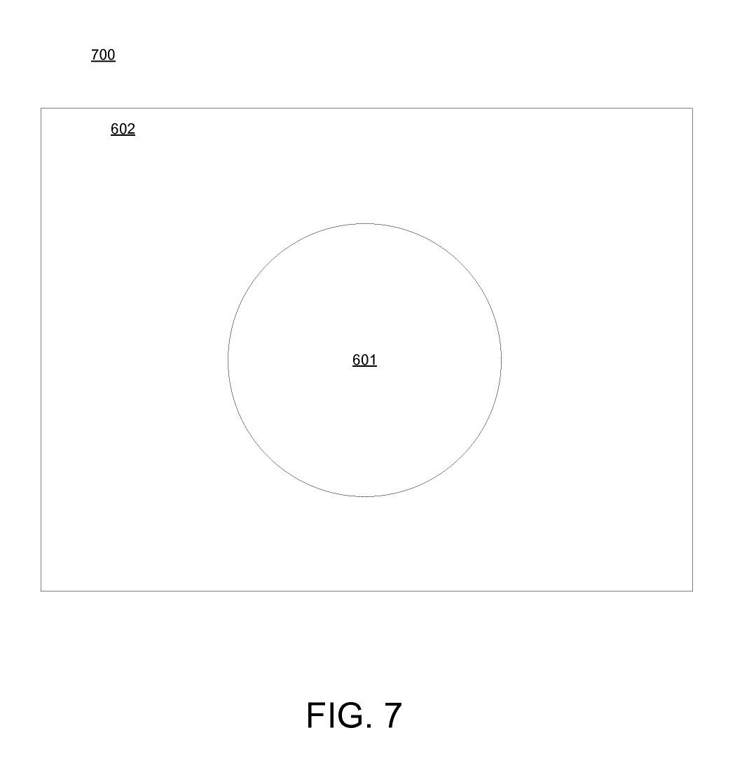

FIG. 7 illustrates a top view of an embodiment of a semiconductor layer 601 on a handle layer 602. The handle layer 602 may be removed, and stressed metal layer 501, adhesion layer 301, and seed layer 202 (in the case of a p-type ingot 201) may be etched off, depending on the application for which semiconductor layer 601 is to be used. Semiconductor layer 601 may have any desired thickness, and be used in any desired application. Semiconductor layer 601 may comprise single- or poly-crystalline silicon in some embodiments.

In block 105, blocks 101-104 may be repeated using ingot 201. Because there is no kerf loss, layers of the ingot 201 may removed from the ingot 201 with relatively little waste, maximizing the number of layers of a semiconductor material that may be formed from a single ingot.

The technical effects and benefits of exemplary embodiments include reduction of waste in semiconductor fabrication.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method for spalling a layer from an ingot of a semiconductor substrate, the method comprising:
forming a metal layer on the ingot of the semiconductor substrate, wherein a tensile stress in the metal layer is configured to cause a fracture in the ingot; and
removing the layer from the ingot at the fracture.

2. The method of claim 1, wherein the metal layer comprises nickel (Ni).

3. The method of claim 1, wherein forming the metal layer comprises electroplating.

4. The method of claim 1, further comprising forming a seed layer on the ingot before forming the metal layer.

5. The method of claim 4, wherein the seed layer comprises palladium (Pd).

6. The method of claim 4, wherein the semiconductor substrate comprises silicon, and the seed layer comprises a layer of titanium (Ti) under a layer of silver (Ag).

7. The method of claim 1, further comprising forming an adhesion layer before forming the metal layer, wherein the adhesion layer comprises nickel (Ni).

8. The method of claim 7, further comprising annealing the adhesion layer at a temperature less than about 500° C.

9. The method of claim 1, wherein removing the layer of the semiconductor substrate from the ingot at the fracture comprises adhering a handle layer to the metal layer.

10. The method of claim 9, wherein the handle layer has a radius of curvature of less than 5 meters.

11. The method of claim 1, wherein the metal layer is less than 50 microns thick.

12. The method of claim 1, wherein the tensile stress in the metal layer is greater than about 100 megapascals.

13. A system for spalling a layer from an ingot of a semiconductor substrate, the system comprising:
a metal layer formed on the ingot of the semiconductor substrate, wherein a tensile stress in the metal layer is configured to cause a fracture in the ingot, and wherein the layer is configured to be removed from the ingot at the fracture.

14. The system of claim 13, wherein the metal layer comprises nickel (Ni).

15. The system of claim 13, further comprising a seed layer formed on the ingot, wherein the semiconductor substrate comprises a p-type semiconductor substrate.

16. The system of claim 13, further comprising an adhesion layer formed underneath the metal layer, wherein the adhesion layer comprises nickel (Ni).

17. The system of claim 13, further comprising a handle layer adhered to the metal layer.

18. The system of claim 16, wherein the handle layer has a radius of curvature of less than 5 meters.

19. The system of claim 13, wherein the metal layer is less than 50 microns thick.

20. The system of claim 13, wherein the tensile stress in the metal layer is greater than about 100 megapascals.
